(19) United States
(12) Patent Application Publication
(10) Pub. No.: US 2015/0153617 A1
(43) Pub. Date: Jun. 4, 2015

(54) LIQUID CRYSTAL DISPLAY DEVICE AND METHOD FOR MANUFACTURING THE SAME

(71) Applicant: Samsung Display Co., Ltd., Yongin-city (KR)

(72) Inventors: Min-Hee KIM, Ansan-si (KR); Min-Jae Kim, Suwon-si (KR); Joon-Hyung Park, Seoul (KR); Jongho Son, Seoul (KR); Keunchan Oh, Cheonan-si (KR); Kyunghee Lee, Suwon-si (KR); Kangseob Jeong, Seongnam-si (KR); Kyungseon Tak, Hwaseong-si (KR); Sung Hwan Hong, Suwon-si (KR)

(73) Assignee: Samsung Display Co., Ltd., Yongin-city (KR)

(21) Appl. No.: 14/281,440

(22) Filed: May 19, 2014

(30) Foreign Application Priority Data
Dec. 2, 2013 (KR) 10-2013-0148623

(51) Int. Cl. G02F 1/1337; G02F 1/1343

(52) U.S. Cl. CPC G02F 1/133711; G02F 1/134309; G02F 1/133788; G02F 1/1337

(57) ABSTRACT

A liquid crystal display device including a first substrate, a first alignment layer provided on the first substrate, a second substrate facing the first substrate, a second alignment layer provided on the second substrate, and a liquid crystal layer provided between the first substrate and the second substrate and including liquid crystal molecules. Each of the first alignment layer and the second alignment layer includes a main alignment layer and an alignment forming layer provided on the main alignment layer. The alignment forming layer is obtained by polymerizing two or more reactive mesogens having light absorption peaks in different wavelengths from each other.

### CROSS-REFERENCE TO RELATED APPLICATIONS

This U.S. non-provisional patent application claims priority under 35 U.S.C. §119 of Korean Patent Application No. 10-2013-0148623, filed on Dec. 2, 2013, which is hereby incorporated by reference for all purposes as if fully set forth herein.

### BACKGROUND

1. Field

The present disclosure relates to a liquid crystal display device having an alignment layer for aligning liquid crystal molecules and a method for manufacturing the same.

2. Discussion of the Background

Generally, liquid crystal display devices are classified as a twisted nematic mode liquid crystal display device, an in-plane switching mode liquid crystal display device, and a vertical alignment mode liquid crystal display device.

In the vertical alignment mode liquid crystal display device, the major axis of the liquid crystal molecule is aligned in a vertical direction to the surface of a substrate, when an electric field is not applied. Thus, viewing angle and contrast ratio are large.

As methods for aligning the liquid crystal molecules in a certain direction, a rubbing method, a photo alignment method, and the like may be used. In the vertical alignment mode liquid crystal device, the liquid crystal molecules may be aligned in a certain direction by using a reactive mesogen in the photo alignment method.

### SUMMARY

The present disclosure provides a liquid crystal display device having a high reliability.

The present disclosure also provides a method for manufacturing a liquid crystal display device having a high reliability.

Additional features of the invention will be set forth in the description which follows, and in part will be apparent from the description, or may be learned by practice of the invention.

Embodiments of the inventive concept provide liquid crystal display devices including a first substrate, a first alignment layer provided on the first substrate, a second substrate facing the first substrate, a second alignment layer provided on the second substrate, and a liquid crystal layer provided between the first substrate and the second substrate and including liquid crystal molecules. Each of the first alignment layer and the second alignment layer includes a main alignment layer and an alignment forming layer provided on the main alignment layer. The alignment forming layer is obtained by polymerizing two or more reactive mesogens having light absorption peaks in different wavelengths from each other.

In some embodiments, each of the reactive mesogen may have the following Formula 1.

P1-sp1-A1-sp2-(A2)m-sp3-A3-sp4-P2 [Formula 1]

In Formula 1, P1 and P2 are independently selected from an acrylate group, a methacrylate group, an epoxy group, an oxetane group, a vinyl-ether group, or a styrene group; Sp1, Sp2, Sp3, and Sp4 are independently selected from a single bond, —CH₂—, —COO—, —CO—, CH═CH—, —COO—CH═CH—, —CH₂OCH₂— and —CH₂O—; A1 and A3 are independently selected from a single bond, a cyclohexyl group, a phenyl group, a thiophenyl group and a polycyclic aromatic group, or a derivative which 1 to 10 sites thereof are substituted by at least one of —F, —Cl, —OCH₃, and an alkyl group having 1 to 6 carbon atoms; A2 is selected from a cyclohexyl group, a phenyl group, a thiophenyl group, a polycyclic aromatic hydrocarbon group, or a derivative which 1 to 10 sites thereof are substituted by at least one of —F, —Cl, —OCH₃, and an alkyl group having 1 to 6 carbon atoms; and m is 1 to 4.

In other embodiments of the inventive concept, methods for manufacturing a liquid crystal display device include disposing a liquid crystal layer between a first substrate and a second substrate, applying an electric field to the liquid crystal layer, applying a first light to the liquid crystal layer, and applying a second light having a shorter wavelength than the first light to the liquid crystal layer, without applying the electric field. The liquid crystal composition comprises a first reactive mesogen, and a second reactive mesogen different from the first reactive mesogen, and the first reactive mesogen has greater reactivity than the second reactive mesogen to the first light.

The liquid crystal display device according to an embodiment of the inventive concept has constant voltage holding ratio, and has decreased defects such as line afterimages, thereby attaining high reliability.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept.

FIG. 1 is a partial plan view of a liquid crystal display device including a plurality of pixels, according to an embodiment of the inventive concept.

FIG. 2 is a cross-sectional view of a liquid crystal display device taken along line I-I′ in FIG. 1.

FIG. 3 is a flowchart illustrating a method for manufacturing a liquid crystal display device according to an embodiment of the inventive concept.

FIGS. 4A, 4B and 4C are cross-sectional views illustrating a method for forming an alignment layer according to an embodiment of the inventive concept.

FIG. 5 is a graph illustrating the absorbance of reactive mesogen, according to an embodiment of the inventive concept, with respect to wavelength.

FIG. 6 is a chart illustrating threshold voltages in a V-T curve of a liquid crystal display device using general reactive mesogen and a liquid crystal display device using reactive mesogen according to an embodiment of the inventive concept.

FIGS. 7A and 7B are graphs illustrating voltage holding ratio according to second exposing time in a liquid crystal display device using a general reactive mesogen, and a liquid crystal display device using reactive mesogen according to an embodiment of the inventive concept.

### DETAILED DESCRIPTION OF THE EXEMPLARY EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

In the drawings, like reference numerals refer to like elements throughout and the dimensions of layers and regions are exaggerated for clarity of illustration. It will be understood that, although the terms first, second, etc. may be used herein to describe various elements, these elements should not be limited by these terms. These terms are only used to distinguish one element from another element. For example, a first element may be designated as a second element without deviation from the scope of the inventive concept, and similarly, the second element may be designated as the first element. As used herein, the singular forms “a,” “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when a layer, region, or element is referred to as being “on,” or “above” another layer, region, or element, it can be directly on, connected or coupled to the other layer, region, or element or intervening layer, region, or elements may be present. Further, it will be understood that when a layer is referred to as being ‘under’ another layer, it can be directly under, and one or more intervening layers may also be present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the inventive concept will be described in detail with reference to the accompanying drawings.

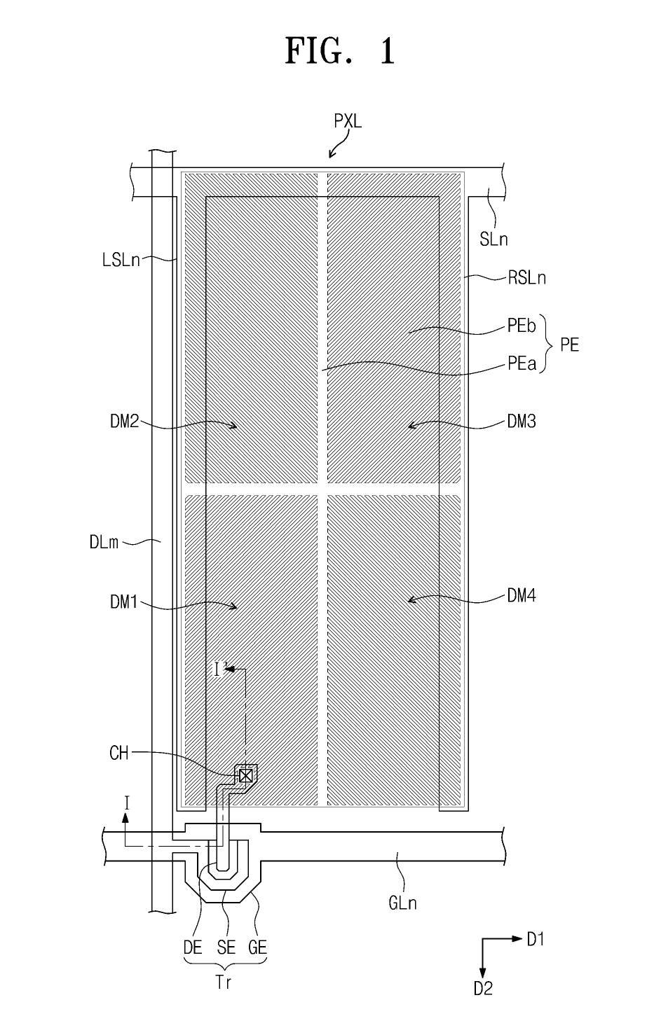

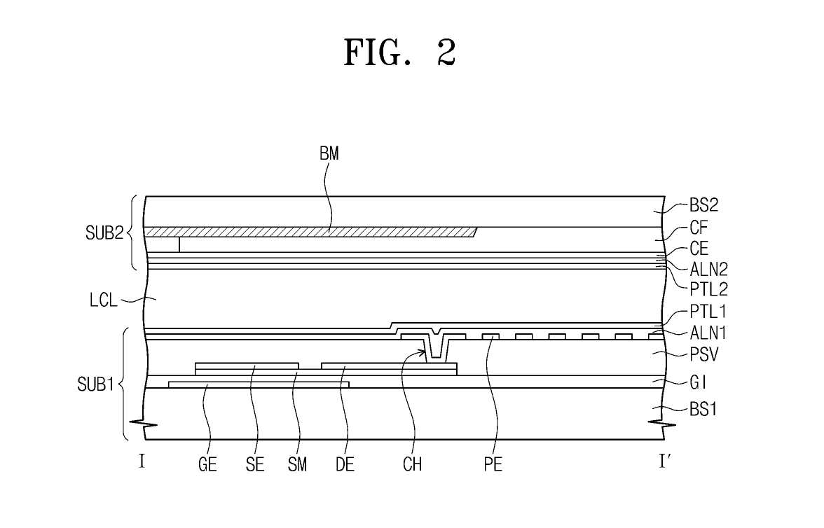

FIG. 1 is a partial plan view of a liquid crystal display device including a plurality of pixels, according to an embodiment of the inventive concept. FIG. 2 is a cross-sectional view of a liquid crystal display device taken along line I-I′ in FIG. 1. Since each of the pixels has the same structure, only one pixel is illustrated for convenience of explanation, and a gate line and a data line adjacent to the pixel are illustrated together.

Referring to FIGS. 1 and 2, the liquid crystal display device includes a first substrate SUB1, a second substrate SUB2 facing the first substrate SUB1, and a liquid crystal layer LCL formed between the first substrate SUB1 and the second substrate SUB2.

The first substrate SUB1 includes a first base substrate BS1, a plurality of gate lines GLn, a plurality of data lines DLm, a plurality of pixels PXL, and a first alignment layer. The first alignment layer includes a first main alignment layer ALN1 and a first alignment forming layer PTL1. The first base substrate BS1 may have a tetragonal shape and may include a transparent insulating material.

In FIGS. 1 and 2, one pixel is illustrated together with n-th gate line GLn among the plurality of gate lines, and m-th data line DLm among the plurality of data lines for convenience of explanation. However, the remaining pixels have similar structure, and hereinafter the n-th gate line GLn and the m-th data line DLm will be referred to as a gate line and a data line, respectively.

The gate line GLn extends in a first direction D1 and formed on the first base substrate BS1. The data line DLm is separated from the gate line GLn and extends in a second direction D2, which crosses the first direction D1, with a gate insulating layer GI therebetween. The gate insulating layer is provided on the whole surface of the first base substrate BS1 and covers the gate line GLn.

Each pixel PXL is connected to a corresponding gate line GLn among the gate lines and a corresponding data line DLm among the data lines. Each pixel PXL includes a thin film transistor Tr, a pixel electrode PE connected to the thin film transistor Tr, and a storage electrode. The thin film transistor Tr includes a gate electrode GE, a gate insulating layer GI, a semiconductor pattern SM, a source electrode SE, and a drain electrode DE. The storage electrode includes a storage line SLn extending in the first direction, and first and second branch electrodes LSLn and RSLn branched from the storage line SLn and extending in the second direction D2.

The gate electrode GE may extend from the gate line GLn or may be provided on a portion of the gate line GLn. The gate electrode GE may be formed by using a metal. The gate electrode GE may be formed by using nickel, chromium, molybdenum, aluminum, titanium, copper, tungsten, and/or an alloy thereof. The gate electrode GE may be formed as a single layer or a multilayer. For example, the gate electrode GE may be a triple layer obtained by stacking molybdenum, aluminum, and molybdenum layers, or a double layer obtained by stacking titanium and copper layers. Alternatively, the gate electrode GE may be a single layer of an alloy of titanium and copper.

The semiconductor pattern SM is provided on the gate insulating layer GI. The semiconductor pattern SM is provided on the gate electrode GE with the gate insulating layer GI therebetween. A portion of the semiconductor pattern SM overlaps with the gate electrode GE. The semiconductor pattern SM includes an active pattern (not shown) provided on the gate insulating layer GI and an ohmic contact layer (not shown) formed on the active pattern. The active pattern may be formed by using an amorphous silicon thin film, and the ohmic contact layer may be formed by using an n⁺ amorphous silicon thin film. The ohmic contact layer makes an ohmic contact between the active pattern and the source electrode SE and the drain electrode DE, respectively.

The source electrode SE extends from the data line DLm. The source electrode SE is formed on the ohmic contact layer and partially overlaps with the gate electrode GE.

The drain electrode DE is spaced apart from the source electrode SE on the semiconductor pattern SM therebetween. The drain electrode DE is formed on the ohmic contact layer and partially overlaps with the gate electrode GE.

The source electrode SE and the drain electrode DE may be formed by using nickel, chromium, molybdenum, aluminum, titanium, copper, tungsten, and/or an alloy thereof. The source electrode SE and the drain electrode DE may be formed as a single layer or a multilayer. For example, the source electrode SE and the drain electrode DE may be a double layer obtained by stacking titanium and copper layers, or may be a single layer formed by using an alloy of titanium and copper.

The upper surface of the active pattern between the source electrode SE and the drain electrode DE is exposed and becomes a channel forming a conductive channel between the source electrode SE and the drain electrode DE, according to the application of a voltage to the gate electrode GE. The source electrode SE and the drain electrode DE overlap with the semiconductor layer SM while exposing the channel.

The pixel electrode PE is connected to the drain electrode DE with a passivation layer PSV therebetween. The pixel electrode PE partially overlaps with the storage line SLn and the first and second branch electrodes LSLn and RSLn, to form a storage capacitor.

The passivation layer PSV covers the source electrode SE, the drain electrode DE, the channel, and the gate insulating layer GI, and has a contact hole CH exposing a portion of the drain electrode DE. The passivation layer PSV may include, for example, silicon nitride or silicon oxide.

The pixel electrode PE is connected to the drain electrode DE through the contact hole CH formed in the passivation layer PSV. The pixel electrode PE may include a stem PEa and a plurality of branches PEb that extend radially from the stem PEa. The stem PEa or the branches PEb may be connected to the drain electrode DE through the contact hole CH.

The stem PEa may be provided in various shapes, for example, in a cross shape as shown. In this case, the pixel PXL may be divided into a plurality of domains by the stem PEa, and the branches PEb may extend in different directions in each domain. The pixel PXL including first to fourth domains DM1, DM2, DM3 and DM4 is illustrated as an exemplary embodiment. The branches PEb are separated so that adjacent branches PEb do not meet. In the region divided by the stem PEa, the branches PEb are parallel to each other. Adjacent branches PEb are separated by micrometers, so as to align the liquid crystal molecules LC in the liquid crystal layer LCL to a certain azimuth angle on a plane parallel to the base substrate.

The pixel electrode PE may be formed by using a transparent conductive material. Particularly, the pixel electrode PE may be formed by using a transparent conductive oxide. The transparent conductive oxide may be indium tin oxide (ITO), indium zinc oxide (IZO), indium tin zinc oxide (ITZO), and the like.

The first main alignment layer ALN1 is formed on the passivation layer PSV, so as to cover the pixel electrode PE. On the first main alignment layer ALN1, a first alignment forming layer PTL1 is provided.

The first main alignment layer ALN1 may be formed of a polymer such as polyimide, polyamic acid, polyamide, polyamic imide, polyester, polyethylene, polyurethane, polystyrene, or a mixture thereof. The first main alignment layer ALN1 may be initially aligned by using a rubbing method or a photo alignment method.

The first alignment forming layer PTL1 may be a polymer obtained by polymerizing two or more kinds of reactive mesogens having light absorption peaks at different wavelengths. The reactive mesogens having light absorption peaks at different wavelengths exhibit different reactivities when a light having a certain wavelength is provided. Thus, light of a certain wavelength may react with only a portion of the mesogens.

In an embodiment of the inventive concept, the reactive mesogen may be selected from the compounds represented by the following Formula 1.

P1-sp1-A1-sp2-(A2)m-sp3-A-3-sp4-P2 [Formula 1]

In Formula 1 P1 is a terminal group including 2 to 6 reactive groups that participate in a polymerization reaction. The reactive groups may induce the polymerization reaction and may include, for example, an acrylate group, a methacrylate group, an epoxy group, an oxetane group, a vinyl-ether group, or a styrene group.

P2 is provided independently from P1 and is a terminal group including 2 to 6 reactive groups that participate in a polymerization reaction. The reactive groups may induce the polymerization reaction and may include, for example, an acrylate group, a methacrylate group, an epoxy group, an oxetane group, a vinyl-ether group, or a styrene group.

Each of Sp1, Sp2, Sp3 and Sp4 independently is at least one among a single bond, —CH₂—, —COO—, —CO—, CH═CH—, —COO—CH═CH—, —CH₂OCH₂— and —CH₂O—.

Each of A1 and A3 independently represents at least one among a single bond, a cyclohexyl group, a phenyl group, a thiophenyl group and a polycyclic aromatic group, or a derivative that from 1 to 10 sites thereof are substituted with at least one of —F, —Cl, —OCH₃, and an alkyl group having 1 to 6 carbon atoms.

A2 is at least one among a cyclohexyl group, a phenyl group, a thiophenyl group, and a polycyclic aromatic hydrocarbon group, or a derivative from 1 to 10 sites thereof are substituted with at least one of —F, —Cl, —OCH₃ and an alkyl group having 1 to 6 carbon atoms.

In Formula 1, m is 1 to 4.

In an embodiment of the inventive concept, the first alignment forming layer PTL1 may be a polymer obtained by polymerizing two kinds of reactive mesogens having light absorption peaks at different wavelengths. The first alignment forming layer PTL1 may have a network structure and may be connected to the first main alignment layer ALN1 as side chains. However, the first alignment forming layer PTL1 is illustrated as a layer shape similar to the first main alignment layer ALN1, for convenience of explanation.

In an embodiment of the inventive concept, the reactive mesogen may include a first reactive mesogen having a light absorption peak at the first wavelength, and a second reactive mesogen having a light absorption peak at the second wavelength shorter than the first wavelength. The first reactive mesogen and the second reactive mesogen may have light absorption peaks in an ultraviolet region.

The first wavelength and the second wavelength may be in the ultraviolet region, for example, from about 10 nm to about 400 nm. In an embodiment of the inventive concept, the first wavelength and the second wavelength may be from about 220 nm to about 350 nm, and for example, the first wavelength may be about 270 nm, and the second wavelength may be about 250 nm.

In an embodiment of the inventive concept, the first reactive mesogen may be at least one selected from the group consisting of the compounds in the following Formulas 2, 3, and 4, and the second reactive mesogen may be at least one selected from the group consisting of the compounds in the following Formulas 5, 6, 7, and 8.

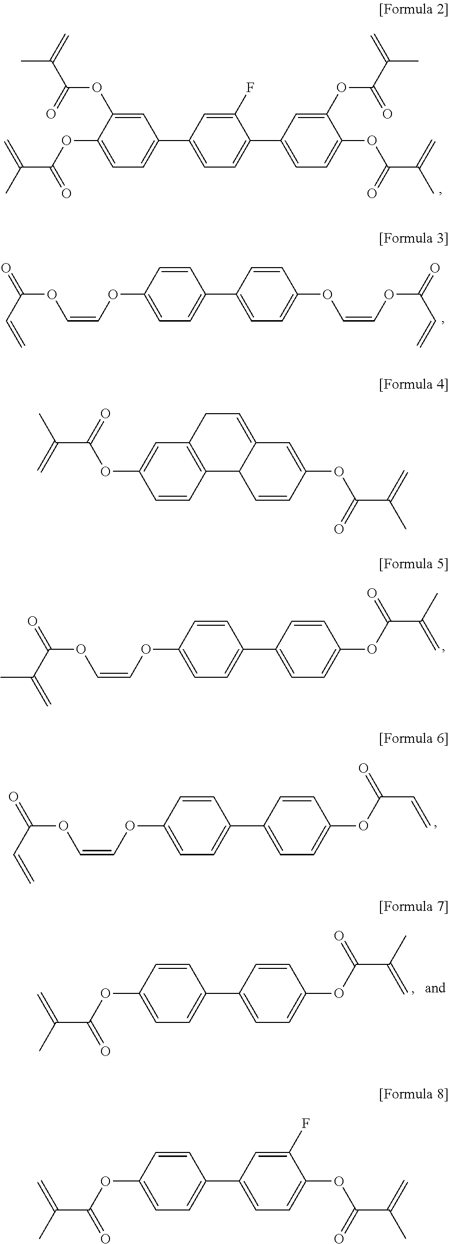

The first main alignment layer ALN1 and the first alignment forming layer PTL1 may include regions aligned in correspondence to the first to fourth domains DM1, DM2, DM3 and DM4 of the pixel electrode PE. In an embodiment of the present invention, the first main alignment layer ALN1 and the first alignment forming layer PTL1 include a first to fourth regions, and the liquid crystal molecules LC are aligned in different directions in the domains DM1, DM2, DM3, and DM4 corresponding to the first to fourth regions.

The second substrate SUB2 includes the second base substrate BS2. A color filter CF, a black matrix BM, a common electrode CE, and a second alignment layer are included on the second base substrate BS2. The second alignment layer includes the second main alignment layer ALN2 and the second alignment forming layer PTL2.

The color filter CF is formed on the second base substrate BS2, and provides colors to the light penetrating the liquid crystal layer LCL. The color filter CF is formed on the second substrate SUB2. However the position of the color filter CF is not limited thereto. The color filter CF may be formed on the first substrate SUB1, for example.

The black matrix BM is formed in correspondence to a blocking region of the first substrate SUB1. The blocking region may be defined as a region in which the data line DLm, the thin film transistor Tr, and the gate line GLn are formed. In the blocking region, the pixel electrode PE is generally not formed, and the liquid crystal molecules LC are not aligned and light leakage may be generated. Thus, the black matrix BM is formed in the blocking region to block the light leakage.

The common electrode CE is formed on the color filter CF and forms an electric field with the pixel electrode PE to drive the liquid crystal layer LCL. The common electrode CE may be formed by using a transparent conductive material. The common electrode CE may be formed by using a conductive metal oxide such as ITO, IZO, ITZO, etc.

The second main alignment layer ALN2 is formed on the common electrode CE. The second alignment forming layer PTL2 is formed on the second main alignment layer ALN2. The second main alignment layer ALN2 and the second alignment forming layer PTL2 are substantially the same as the first main alignment layer ALN1 and the first alignment forming layer PTL1, except for being formed on the second substrate SUB2. Therefore, repeated explanation will be omitted.

Between the first substrate SUB1 and the second substrate SUB2, the liquid crystal layer LCL including the liquid crystal molecules LC is provided. The liquid crystal layer LCL may have a negative dielectric anisotropy or a positive dielectric anisotropy.

In the liquid crystal display device, when a gate signal is applied to the gate line GLn, the thin film transistor Tr is turned-on. Thus, a data signal applied to the data line DLm may be applied to the pixel electrode PE through the thin film transistor Tr. When the thin film transistor Tr is turned-on, and the data signal is applied to the pixel electrode PE, an electric field may be formed between the pixel electrode PE and the common electrode CE. The liquid crystal molecules LC are driven by the electric field generated by the voltage difference applied to the common electrode CE and the pixel electrode PE. Therefore, the dosage penetrating the liquid crystal layer may be changed and an image may be displayed.

Meanwhile, the liquid crystal display device according to an embodiment of the inventive concept may have various pixel structures. For example, two gate lines and one data line may be connected to one pixel according to an embodiment of the inventive concept, and one gate line and two data lines may be connected to one pixel according to another embodiment. Differently, one pixel may include two sub pixels to which two different voltages are applied. In this case, a high voltage may be applied to one sub pixel and a low voltage may be applied to another sub pixel. In addition, the elements in the pixel such as the gate electrode, the source electrode, and the drain electrode may be disposed in a structure different from the illustrated one according to another embodiment of the inventive concept.

In addition, in a liquid crystal display device according to an embodiment of the inventive concept, the shapes of the pixel electrode and the common electrode may be different from the above-described shapes. For example, a pixel electrode having a plurality of branches is provided, however is not limited thereto. The pixel electrode may be provided with other shapes.

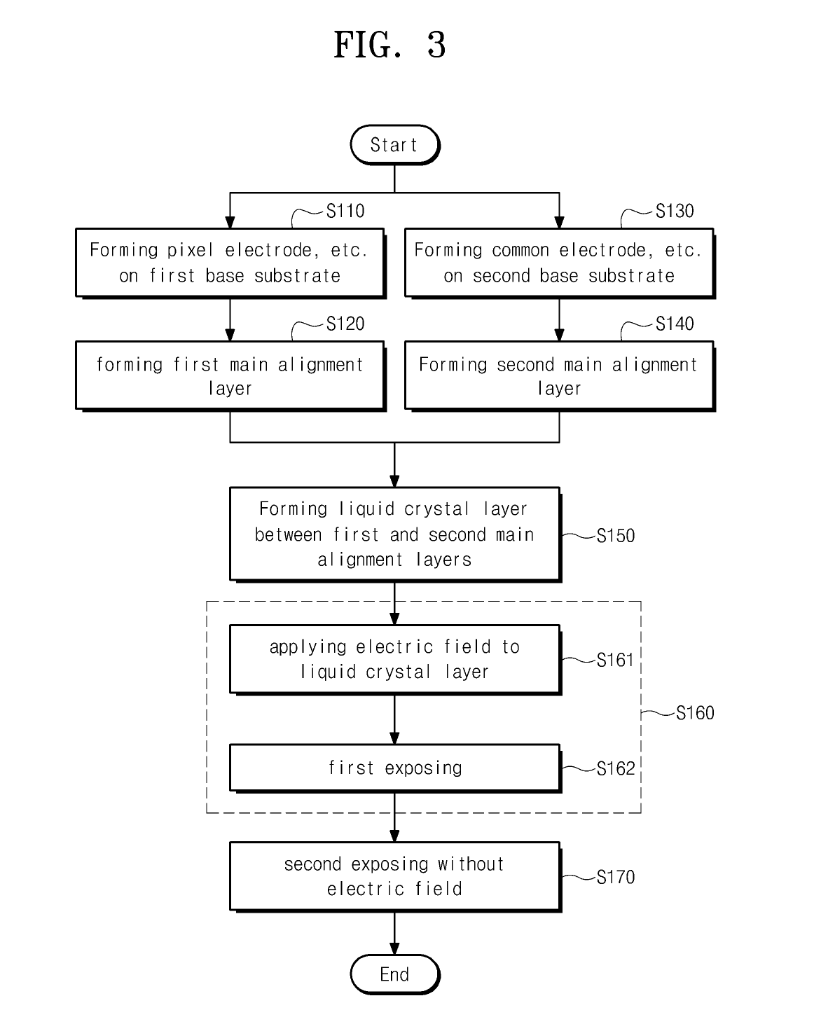

FIG. 3 is a flowchart illustrating a method for manufacturing a liquid crystal display device according to an embodiment of the inventive concept. Referring to FIG. 3, a pixel electrode, etc. are formed on a first base substrate (S110). A first main alignment layer is then formed on the first base substrate (S120). Separately, a common electrode, etc. are formed on a second base substrate (S130). Then, a second main alignment layer is formed on the second base substrate (S140). A liquid crystal layer is provided between the first main alignment layer and the second main alignment layer (S150). The liquid crystal layer includes reactive mesogens. During a first exposure process (S160) an electric field is applied to the liquid crystal layer (Step S161), and the liquid crystal layer is firstly exposed (S162) (S160). Then, during a second exposure process (S170), the electric field is removed, and the liquid crystal layer is exposed to form first and second alignment forming layers.

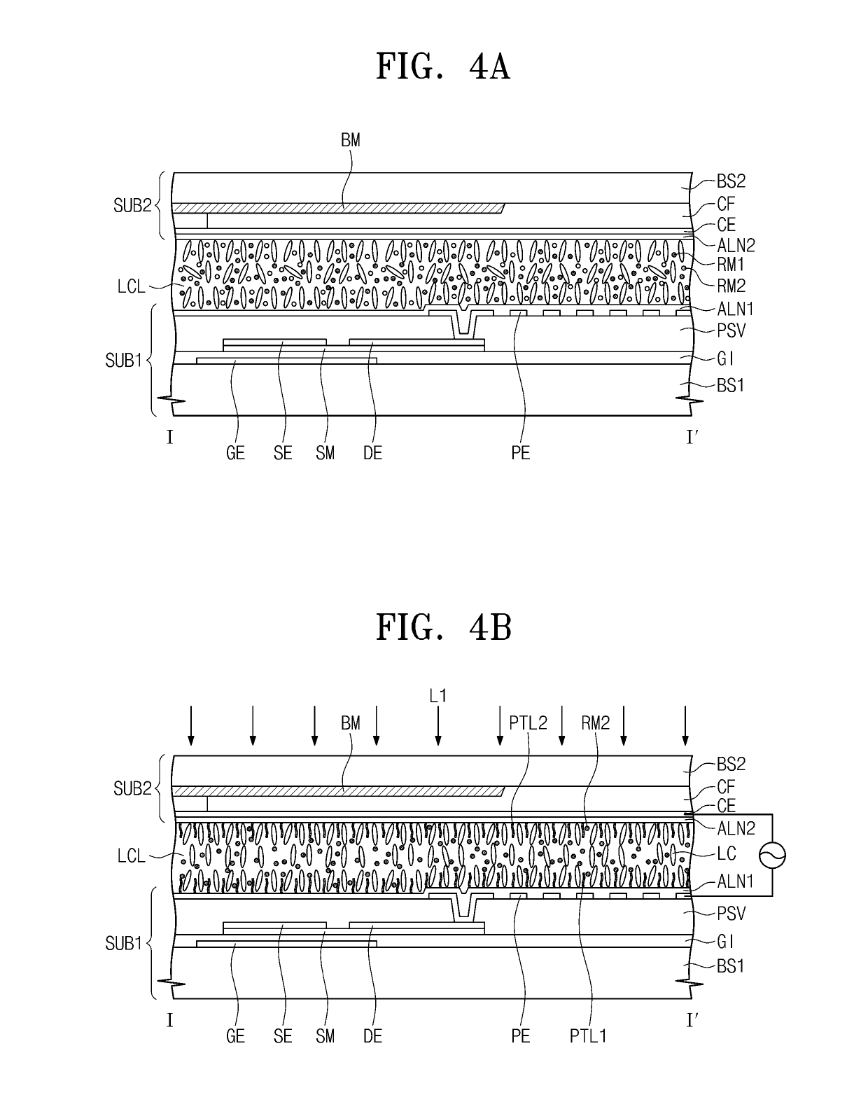

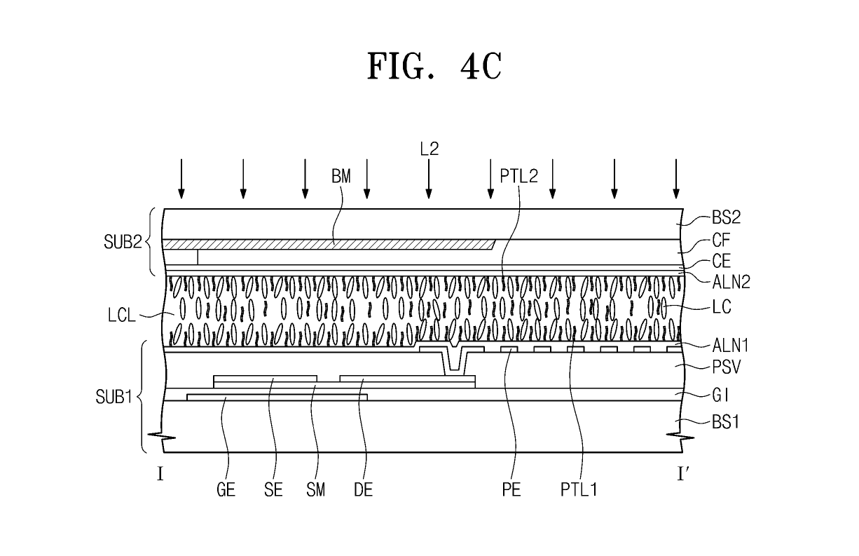

FIGS. 4A, 4B, and 4C are cross-sectional views illustrating a method for forming an alignment layer according to an embodiment of the inventive concept. Hereinafter a method for manufacturing a liquid crystal display device according to an embodiment of the inventive concept will be explained in detail referring to FIGS. 1 to 3, 4A, 4B, and 4C.

First, referring to FIGS. 1 and 2, the step of forming a pixel electrode PE, etc. on a first base substrate BS1 will be explained herein below. A gate pattern is formed on the first base substrate BS1. The gate pattern includes a gate line GLn and a storage electrode. The gate pattern may be formed by using a photolithography process.

A gate insulating layer GI is formed on the gate pattern. A semiconductor layer SM is formed on the gate pattern. The semiconductor layer SM may include an active pattern and an ohmic contact layer formed on the active pattern. The semiconductor layer SM may be formed by using the photolithography process.

A data pattern is formed on the semiconductor layer SM. The data pattern includes a data line DLm, a source electrode SE, and a drain electrode DE. The data pattern may be formed by using the photolithography process. In this case, the semiconductor layer SM and the data pattern may be formed by one half mask, one diffraction mask, or the like.

A passivation layer PSV is formed on the data pattern. The passivation layer PSV includes a contact hole CH exposing a portion of the drain electrode DE and may be formed by using the photolithography process.

A pixel electrode PE is formed on the passivation layer PSV and is connected to the drain electrode DE through the contact hole CH. The pixel electrode PE may be formed by using the photolithography process.

Then, a first main alignment layer ALN1 is formed on the first base substrate BS1 on which the pixel electrode PE, etc. are formed. The first main alignment layer ALN1 may be formed by coating a first alignment solution including a polymer such as polyimide and a monomer of the polymer on the first base substrate BS1, and then heating the first alignment solution.

Referring to FIGS. 1 and 2 again, the step of forming a second substrate SUB2 will be explained herein below. A color filter CF designating colors is formed on the second base substrate BS2. A common electrode CE is formed on the color filter CF. The color filter CF and the common electrode CE may be respectively formed by various methods, such as a photolithography process.

A second main alignment layer ALN2 is formed on the second base substrate BS2 on which the common electrode CE, etc. are formed. The second main alignment layer ALN2 is formed by coating a second alignment solution on the second substrate SUB2 and heating the second alignment solution. The second main alignment layer ALN2 may include the same components as those of the first main alignment layer ALN1 and may be formed through the same process. Since the second main alignment layer ALN2 is formed similarly to the first main alignment layer ALN1, the formation of the second main alignment layer ALN2 is not shown in detail.

As illustrated in FIG. 4A, the first substrate SUB1 and the second substrate SUB2 are disposed to face to each other, and a liquid crystal layer LCL is injected between the first substrate SUB1 and the second substrate SUB2.

The liquid crystal layer LCL is formed of a liquid crystal composition including liquid crystal molecules LC having dielectric anisotropy, and at least two reactive mesogens having light absorption peaks at different wavelengths. The liquid crystal may have liquid crystal molecules LC having various structures, for example, alkenyl-based and/or alkoxy-based liquid crystal molecules.

The reactive mesogen refers to photo curable particles, that is, photo cross-linkable low molecular weight or high molecular weight copolymers, and exhibits a chemical reaction, such as a polymerization reaction, when a light of a certain wavelength, for example ultraviolet light, is applied. The reactive mesogen may include, for example, an acrylate group, a methacrylate group, an epoxy group, an oxetane group, a vinyl-ether group, or a styrene group. The reactive mesogen may be a material having a bar shape, a banana shape, a board shape, or a disc shape.

The liquid crystal composition includes two or more kinds of reactive mesogens having photo absorption peaks at different wavelengths. The reactive mesogens having photo absorption peaks at different wavelengths exhibit different reactivity when a light having a certain wavelength is provided. Thus, when a light having a certain wavelength is provided to the liquid crystal composition, a portion of the mesogens may be reacted prior to the remaining mesogens. Particularly, the reactive mesogens absorbing a light having a relatively longer wavelength may be reacted by a smaller energy, as compared to the reactive mesogens absorbing a light having a relatively short wavelength. Also, the reaction rate may be faster.

In an embodiment of the inventive concept, the reactive mesogen may be selected from the compounds represented by the following Formula 1.

P1-sp1-A1-sp2-(A2)m-sp3-A3-sp4-P2 [Formula 1]

Where P1 is a terminal group including 2 to 6 reactive groups participating in a polymerization reaction. The reactive group may include, for example, an acrylate group, a methacrylate group, an epoxy group, an oxetane group, a vinyl-ether group, or a styrene group.

P2 is provided independently from P1 and is a terminal group including 2 to 6 reactive groups participating in a polymerization reaction. The reactive group may include, for example, an acrylate group, a methacrylate group, an epoxy group, an oxetane group, a vinyl-ether group, or a styrene group.

Each of Sp1, Sp2, Sp3 and Sp4 independently selected from a single bond, —CH₂—, —COO—, —CO—, CH═CH—, —COO—CH═CH—, —CH₂OCH₂— and —CH₂O—, and corresponds to a spacer group.

Each of A1 and A3 independently represents a single bond, a cyclohexyl group, a phenyl group, a thiophenyl group and a polycyclic aromatic group, or a derivative thereof substituted by 1 to 10 numbers of at least one of —F, —Cl, —OCH₃, and an alkyl group having 1 to 6 carbon atoms.

A2 is at least one among a cyclohexyl group, a phenyl group, a thiophenyl group and a polycyclic aromatic hydrocarbon group, or a derivative thereof substituted from 1 to 10 time with at least one of —F, —Cl, —OCH₃ and an alkyl group having 1 to 6 carbon atoms.

In Formula 1, m is 1 to 4.

In an embodiment of the inventive concept, the first alignment forming layer PTL1 may be a polymer obtained by polymerizing two kinds of reactive mesogens having light absorption peaks at different wavelengths. In this case, the first alignment forming layer PTL1 may include a first reactive mesogen RM1 having a light absorption peak at the first wavelength and a second reactive mesogen RM2 having a light absorption peak at the second wavelength shorter than the first wavelength. The first reactive mesogen RM1 and the second reactive mesogen RM2 may have light absorption peaks in an ultraviolet region.

The first wavelength and the second wavelength of the first and second reactive mesogens RM1 and RM2 may be positioned in the ultraviolet region, for example, from about 10 nm to about 400 nm. In an embodiment of the inventive concept, the first wavelength and the second wavelength may be positioned in a range from about 220 nm to about 350 nm, for example, the first wavelength may be about 270 nm, and the second wavelength may be about 250 nm.

In an embodiment of the inventive concept, the first reactive mesogen RM1 may be selected from the materials having high reactivity to a light having a relatively lower wavelength, when compared to the second reactive mesogen RM2. In this case, the first reactive mesogen RM1 may include a reactive group having absorbance at a longer wavelength than the second mesogen RM2, or may include a more conjugated structure. For example, the conjugation degree of each reactive mesogen may be controlled by disposing a spacer group that may be conjugated or non-conjugated with A1 to A3, between the conjugated structures of A1 to A3 and the reactive groups of P1 and P2. When the conjugation degree is large, the reactive mesogen may absorb light having a relatively longer wavelength.

In an embodiment of the inventive concept, the first reactive mesogen RM1 may be at least one selected from the group consisting of the compounds in the following Formulas 2, 3, and 4, and the second reactive mesogen RM2 may be at least one selected from the group consisting of the compounds in the following Formulas 5, 6, 7, and 8.

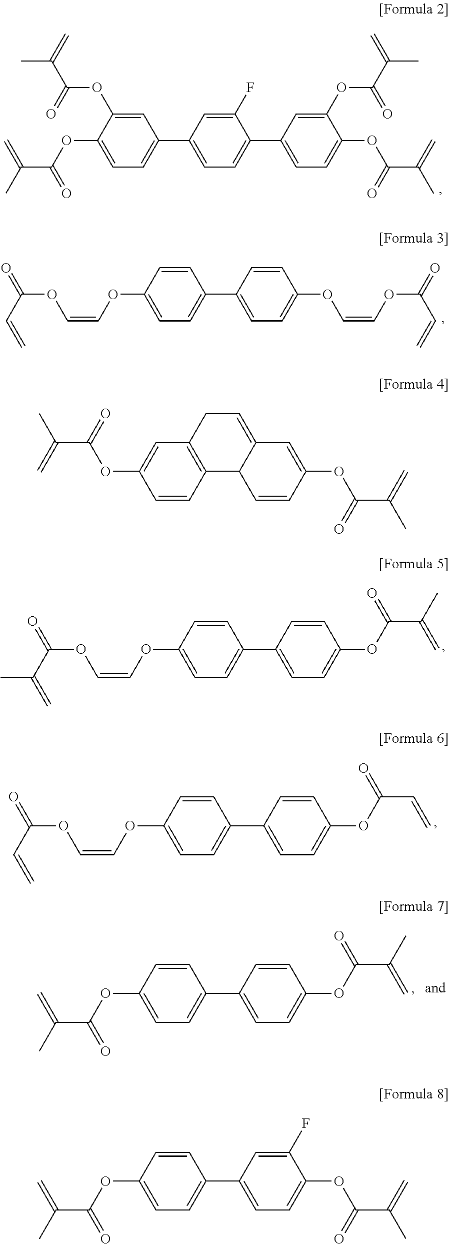

In an embodiment of the inventive concept, the first reactive mesogen RM1 and the second reactive mesogen RM2 of the above Formulas 2-8 are suggested as examples, and any kinds of the first and second reactive mesogens RM1 and RM2 may be used without specific limitation, as long as they have different light absorption peaks and different reactivity with respect to a light having a certain wavelength. For example, even though a reactive mesogen is classified as the first reactive mesogen in the embodiment, this mesogen may be classified as the second reactive mesogen, if another reactive mesogen having an absorbance at a longer wavelength is used.

In an embodiment of the inventive concept, the liquid crystal composition may further include an additive such as a photo initiator for initiating the reaction of the reactive mesogens. The liquid crystal composition may include an antioxidant for preventing the oxidation of the liquid crystal molecules LC in the liquid crystal layer.

Referring to FIG. 4B, an electric field is applied to the liquid crystal composition. The electric field may be formed by applying different voltages to the pixel electrode PE and the common electrode CE. In addition, a first light L1 is applied to the liquid crystal layer LCL to perform the first exposure process, while applying the electric field to the liquid crystal composition.

The first light L1 has a longer wavelength than a second light L2 (see FIG. 4C), which will be explained later. The first light L1 may be a light in an ultraviolet region and may have a wavelength of from about 10 nm to about 400 nm, in an embodiment of the inventive concept. In addition, the wavelength may be from about 220 nm to about 350 nm, according to another embodiment of the inventive concept. According to further another embodiment of the inventive concept, the first light L1 may have a maximum absorption wavelength of the first reactive mesogen RM1, that is, a first wavelength. The first light L1 may be polarized, or may be a non-polarized light.

In an embodiment of the inventive concept, the first light L1 may be provided to the liquid crystal composition at from about 0.1 J/cm² to about 50 J/cm², for from about 30 seconds to about 200 seconds. However, the light energy and the exposing time are not limited thereto, and may be changed according to the kinds of the first and second reactive mesogens RM1 and RM2. After the exposure, the first alignment forming layer PTL1 is formed on the first base substrate BS1, and the second alignment forming layer PTL2 is formed on the second base substrate BS2.

The first reactive mesogen RM1 and the second reactive mesogen RM2 may react to the first light L1. However, since the first reactive mesogen RM1 has higher reactivity with respect to the first light L1, the reaction of the first reactive mesogen RM1 predominantly occurs, and the second reactive mesogen RM2 may substantially remain in an unreacted state, even though the reaction of the first reactive mesogen RM1 is completed.

The first reactive mesogen RM1 is polymerized on the first main alignment layer ALN1 and the second main alignment layer ALN2, and forms a first alignment forming layer PTL1 and a second alignment forming layer PTL2. In detail, when an electric field is applied to the liquid crystal molecules LC, the first and second reactive mesogens RM1 and RM2 may be aligned in the substantially same direction as the surrounding liquid crystal molecules LC. In this state, when the first light L1 is radiated, the first reactive mesogens RM1 may be polymerized by the first light L1, thereby forming a network between the first reactive mesogens RM1. Adjacent first reactive mesogens RM1 may bond and form a branched chain. Since the first reactive mesogen RM1 forms the network while the liquid crystal molecules LC maintains the alignment state, the first reactive mesogen RM1 may have a certain alignment along the average alignment direction of the liquid crystal molecules LC. Therefore, the liquid crystal molecules LC adjacent to the network have a line tilt angle (pre-tilt angle) even when the electric field is removed.

Then, referring to FIG. 4C, the second light L2 having a shorter wavelength than the first light L1 (See FIG. 4B) is applied to perform the second exposure operation, while the electric field is not applied. The second light L2 may be a light in an ultraviolet region and may have the wavelength of from about 10 nm to about 400 nm, in an embodiment of the inventive concept. In addition, the wavelength may be from about 220 nm to about 350 nm, according to another embodiment of the inventive concept. According to further another embodiment of the inventive concept, the second light L2 may have a maximum absorption wavelength of the second reactive mesogen RM2, that is, a second wavelength. The second light L2 may be polarized, or may be a non-polarized light.

In an embodiment of the inventive concept, the second light L2 may be provided to the liquid crystal composition at from about 0.05 mW/cm² to about 0.6 mW/cm², for from about 10 minutes to about 90 minutes. However, the light energy and the exposing time are not limited thereto, and may be changed according to the kinds of the first and second reactive mesogens RM1 and RM2.

By applying the second light L2 to the first and second alignment forming layers PTL1 and PTL2 in the second exposing step, the reaction of the unreacted sites of the first and second alignment forming layers PTL1 and PTL2 may be completed. Thus, the first and second alignment forming layers PTL1 and PTL2 are stabilized. In addition, the remaining unreacted second reactive mesogen RM2 is polymerized at the second exposing step.

In an embodiment of the inventive concept, the remaining second reactive mesogens react to the second exposure, and the deformation of the liquid crystal molecules and accompanying defects may be prevented. The liquid crystal molecules composing the major part of the liquid crystal composition may be degenerated through the first and second exposure. For example, alkenyl-based liquid crystal may be degenerated into radicals or ions by the first light and/or the second light. In this case, the radicals or the ions and another liquid crystal may react, and additional liquid crystal molecules may induce the degeneration of the liquid crystal molecules. As a result, the liquid crystal molecules may not be appropriately driven, and the voltage holding ratio may decrease and the reliability of an image liquid crystal display device may decrease.

However, in an embodiment of the inventive concept, the second reactive mesogen remains after the first exposure, and the degeneration of the liquid crystal molecules possibly generated during the first exposure and the second exposure may be prevented or decreased. That is, even though a portion of the liquid crystal molecules are degenerated into the radicals or ions, the radicals or the ions may react with the second reactive mesogen first. Since the reactivity of the second reactive mesogen is greater than the liquid crystal molecules, additional degeneration of the liquid crystal molecules may be prevented.

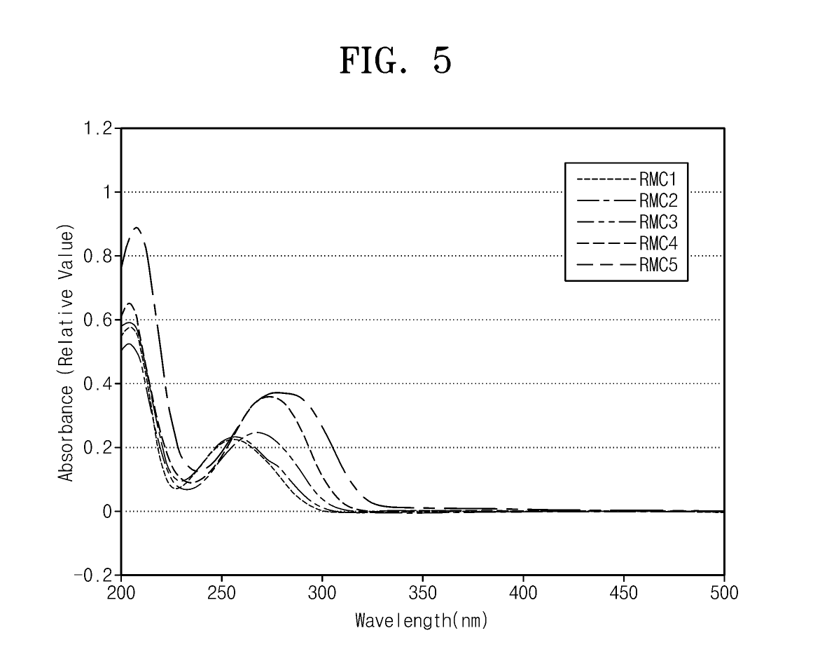

FIG. 5 is a graph illustrating the absorbance of reactive mesogens according to an embodiment of the inventive concept with respect to wavelength. C1 to C5 in FIG. 5 respectively represent reactive mesogen compound 1 to reactive mesogen compound 5, and the chemical formulae of the reactive mesogen compounds 1 to 5 are illustrated in the following Table 1.

TABLE 1

| Reactive mesogens | Formula |
|---|---|
| Reactive mesogen compound 1 (C1) | 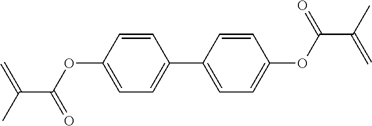 [SMILES: C=C(C)C(=O)Oc1ccc(-c2ccc(OC(=O)C(=C)C)cc2)cc1] |
| Reactive mesogen compound 2 (C2) | 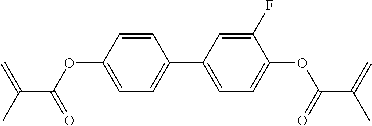 [SMILES: C=C(C)C(=O)Oc1ccc(-c2ccc(OC(=O)C(=C)C)c(F)c2)cc1] |
| Reactive mesogen compound 3 (C3) | 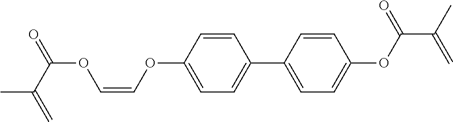 [SMILES: C=C(C)C(=O)O/C=C\Oc1ccc(-c2ccc(OC(=O)C(=C)C)cc2)cc1] |
| Reactive mesogen compound 4 (C4) | 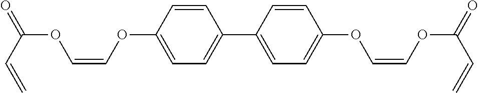 [SMILES: C=CC(=O)O/C=C\Oc1ccc(-c2ccc(O/C=C\OC(=O)C=C)cc2)cc1] |
| Reactive mesogen compound 5 (C5) | 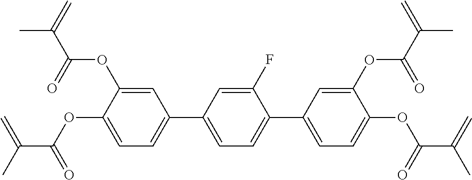 [SMILES: C=C(C)C(=O)Oc1ccc(-c2ccc(-c3ccc(OC(=O)C(=C)C)c(OC(=O)C(=C)C)c3)c(F)c2)cc1OC(=O)C(=C)C] |

As illustrated in FIG. 5, reactive mesogen compounds 1 to 5 have different absorption peaks. Particularly, reactive mesogen compounds 1 to 5 have the absorption peaks in the wavelength range from about 220 nm to about 350 nm. Reactive mesogen compounds 1 to 3 have absorption peaks in a relatively short wavelength range when compared to reactive mesogen compounds 4 and 5. Reactive mesogen compounds 1 to 3 have higher reactivity to a light having a short wavelength, and reactive mesogen compounds 4 and 5 have higher reactivity to a light having a relatively long wavelength.

In an embodiment of the inventive concept, at least one among reactive mesogen compounds 4 and 5 may be used as the first reactive mesogen, and at least one among reactive mesogen compounds 1 to 3 may be used as the second reactive mesogen.

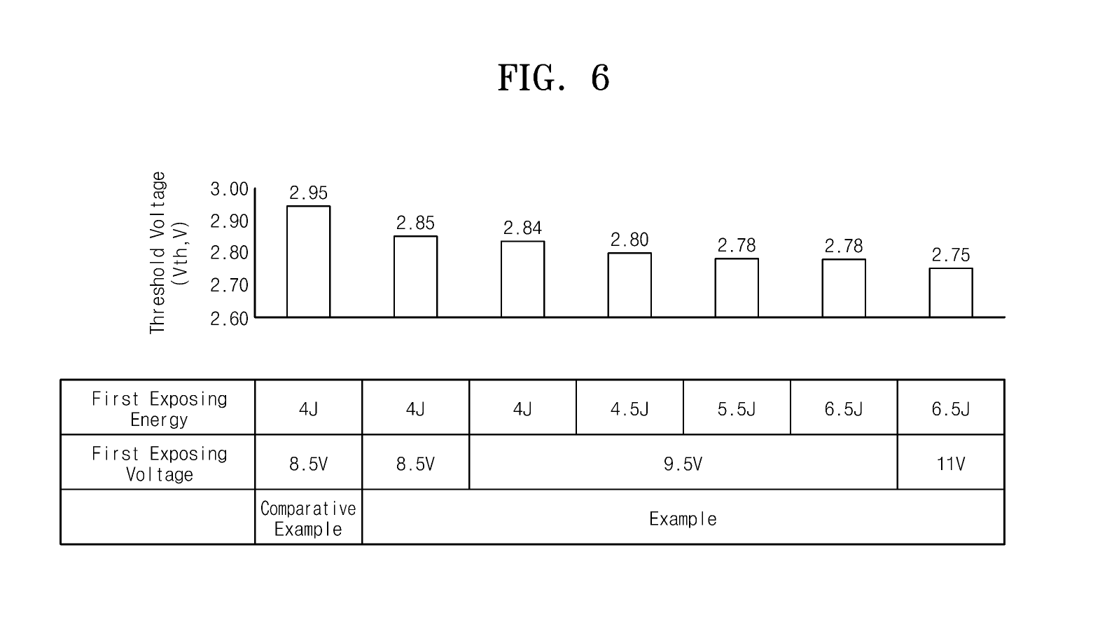

FIG. 6 is a chart illustrating threshold voltages in a V-T curve of a liquid crystal display device using a general reactive mesogen and a liquid crystal display device using a reactive mesogen according to an embodiment of the inventive concept.

In FIG. 6, a comparative example is for a liquid crystal display device using a general reactive mesogen. The comparative example shows a threshold voltage (V) when manufacturing a liquid crystal display device using one optional reactive mesogen. In the comparative example, the exposing energy of the first exposure was about 4 J/cm², and the exposing voltage was about 8.5 V. Example shows a threshold voltage (V) when manufacturing a liquid crystal display device using two different kinds of reactive mesogens. In the example, the exposing energy of the first exposure was about 4 J/cm², about 4.5 J/cm², about 5.5 J/cm², and about 6.5 J/cm², and the exposing voltage was about 8.5 V, about 9.5 V, and about 11 V. In the example and the comparative example, the remaining conditions other than the kinds of the reactive mesogen(s), the exposing energy, and the exposing voltage were the same.

Referring to FIG. 6, the threshold voltage in the comparative example was about 2.95 V, however the threshold voltage in the example was about 2.85 V (decreased by about 0.1 V) under the same conditions. In addition, when the exposing energy increases or the exposing voltage increases, during the first exposure, the threshold voltage decreases. Therefore, it would be confirmed that the threshold voltage of the liquid crystal display device may be controlled by changing the conditions of the first exposure, that is, the exposing energy and the exposing voltage.

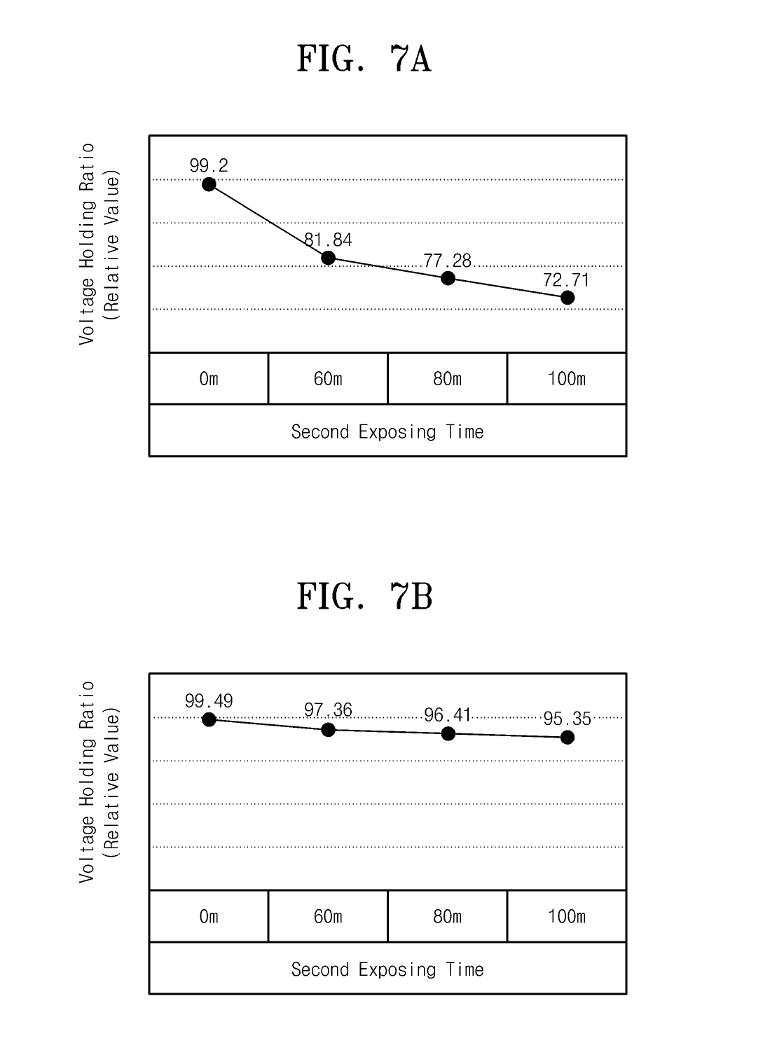

FIGS. 7A and 7B are graphs illustrating voltage holding ratio according to second exposing time, in a liquid crystal display device using a general reactive mesogen and a liquid crystal display device using a reactive mesogen according to an embodiment of the inventive concept.

FIG. 7A is for the liquid crystal display device using a general reactive mesogen. In FIG. 7A, the liquid crystal display device is manufactured by using one kind of optional reactive mesogen, and the change of the voltage holding ratio is illustrated according to the change of the second exposing time in a finally manufactured liquid crystal display device.

FIG. 7B is for a liquid crystal display device according to an embodiment of the inventive concept. In FIG. 7B, the liquid crystal display device is manufactured by using one kind of reactive mesogen having a light absorption peak at a shorter wavelength than the reactive mesogen used in FIG. 7A, in addition to one kind of the reactive mesogen used in FIG. 7A, that is, by using two kinds of reactive mesogens. In FIG. 7B, the change of the voltage holding ratio is illustrated according to the change of the second exposing time, in a finally manufactured liquid crystal display device. In the example and the comparative example, the remaining conditions other than the number and kind of the reactive mesogen(s) were the same.

Referring to FIG. 7A, the voltage holding ratio decreases as the second exposing time increases, in the general liquid crystal display device. Particularly, the voltage holding ratio was about 99.2 without the second exposure. However, the voltage holding ratio decreased to about 72.71 when the second exposure was performed for about 100 minutes.

Referring to FIG. 7B, in a liquid crystal display device according to an embodiment of the inventive concept, the voltage holding ratio may be maintained as the second exposing time increases. That is, the voltage holding ratio was about 99.49 without the second exposure, and the voltage holding ratio was about 95.35, even though the second exposure was performed for about 100 minutes.

Therefore, in the liquid crystal display device including different reactive mesogens according to an embodiment of the inventive concept, the voltage holding ratio may be maintained to an appropriate degree, and defects possibly generated due to the decrease of the voltage holding ratio, for example, line afterimages, may be prevented or reduced.

The above-disclosed subject matter is to be considered illustrative and not restrictive, and the appended claims are intended to cover all such modifications, enhancements, and other embodiments, which fall within the true spirit and scope of the inventive concept.

Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device, comprising:
a first substrate;
a first alignment layer disposed on the first substrate;
a second substrate facing the first substrate;
a second alignment layer disposed on the second substrate; and
a liquid crystal layer disposed between the first substrate and the second substrate,
wherein each of the first alignment layer and the second alignment layer comprises a main alignment layer and an alignment forming layer disposed on the main alignment layer, and the alignment forming layer is obtained by polymerizing reactive mesogens having different light absorption peaks.

2. The liquid crystal display device of claim 1, wherein each of the reactive mesogens has following Formula 1:
P1-sp1-A1-sp2-(A2)m-sp3-A3-sp4-P2, wherein, [Formula 1]
P1 and P2 are independently selected from an acrylate group, a methacrylate group, an epoxy group, an oxetane group, a vinyl-ether group, and a styrene group,
Sp1, Sp2, Sp3 and Sp4 are independently selected from a single bond, —CH₂—, —COO—, —CO—, CH═CH—, —COO—CH═CH—, —CH₂OCH₂—, and —CH₂O—,
A1 and A3 are independently selected from a single bond, a cyclohexyl group, a phenyl group, a thiophenyl group, a polycyclic aromatic group, and derivatives which 1 to 10 sites thereof are substituted by at least one of —F, —Cl, —OCH₃, and an alkyl group having 1 to 6 carbon atoms,
A2 is selected from a cyclohexyl group, a phenyl group, a thiophenyl group, a polycyclic aromatic hydrocarbon group, and derivatives which 1 to 10 sites thereof are substituted by at least one of —F, —Cl, —OCH₃, and an alkyl group having 1 to 6 carbon atoms, and
m ranges from 1 to 4.

3. The liquid crystal display device of claim 2, wherein the reactive mesogen comprises:
a first reactive mesogen having a light absorption peak at a first wavelength; and
a second reactive mesogen having a light absorption peak at a second wavelength that is shorter than the first wavelength.

4. The liquid crystal display device of claim 3, wherein the first wavelength and the second wavelength are in a range of about 220 nm to about 350 nm.

5. The liquid crystal display device of claim 3, wherein the first reactive mesogen is selected from the group consisting of compounds of following Formulas 2, 3, and 4:

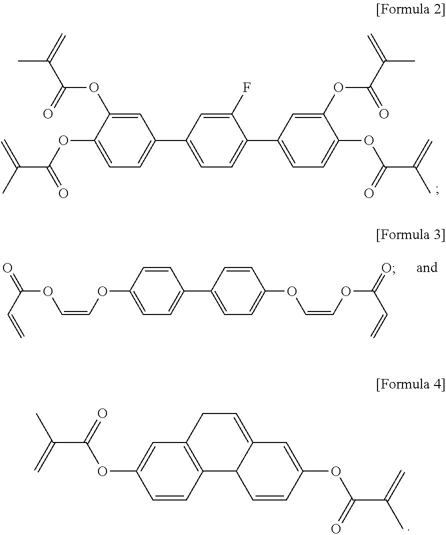

6. The liquid crystal display device of claim 5, wherein the second reactive mesogen is selected from the group consisting of compounds of following Formulas 5, 6, 7, and 8:

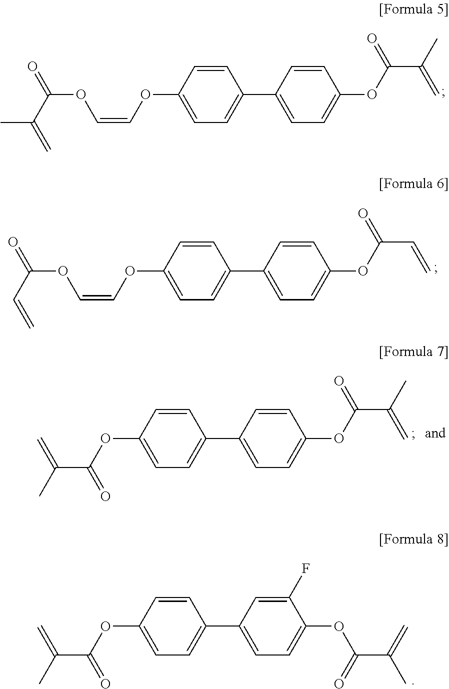

7. The liquid crystal display device of claim 1, further comprising:
a pixel electrode disposed on the first substrate; and
a common electrode disposed on the second substrate.

8. The liquid crystal display device of claim 7, wherein the pixel electrode comprises a stem and branches extending from the stem.

9. The liquid crystal display device of claim 8, wherein:
the first substrate comprises pixel regions having domains; and
the branches extend in different directions in each of the domains.

10. A method of manufacturing a liquid crystal display device, the method comprising:
disposing a liquid crystal layer between a first substrate and a second substrate;
applying an electric field to the liquid crystal layer;
applying a first light to the liquid crystal layer; and
applying a second light having a shorter wavelength than the first light to the liquid crystal layer, without applying the electric field,
wherein the liquid crystal composition comprises first and second reactive mesogens, the first reactive mesogens having a greater reactivity than the second reactive mesogens to the first light.

11. The method of claim 10, wherein the reactive mesogens have following Formula 1:
P1-sp1-A1-sp2-(A2)m-sp3-A3-sp4-P2, wherein, [Formula 1]
P1 and P2 are independently selected from an acrylate group, a methacrylate group, an epoxy group, an oxetane group, a vinyl-ether group, and a styrene group,
Sp1, Sp2, Sp3 and Sp4 are independently selected from a single bond, —CH₂—, —COO—, —CO—, CH═CH—, —COO—CH═CH—, —CH₂OCH₂—, and —CH₂O—,
A1 and A3 are independently selected from a single bond, a cyclohexyl group, a phenyl group, a thiophenyl group, a polycyclic aromatic group, and derivatives which 1 to 10 sites thereof are substituted by at least one of —F, —Cl, —OCH₃, and an alkyl group having 1 to 6 carbon atoms,
A2 is selected from a cyclohexyl group, a phenyl group, a thiophenyl group, a polycyclic aromatic hydrocarbon group, and derivatives which 1 to 10 sites thereof are substituted by at least one of —F, —Cl, —OCH₃, and an alkyl group having 1 to 6 carbon atoms, and
m ranges from 1 to 4.

12. The method of claim 11, wherein the reactive mesogen comprises:
a first reactive mesogen having a light absorption peak at a first wavelength; and
a second reactive mesogen having a light absorption peak at a second wavelength that is shorter than the first wavelength.

13. The method of claim 12, wherein the first wavelength and the second wavelength are in a range of about 220 nm to about 350 nm.

14. The method of claim 12, wherein the first reactive mesogen is selected from the group consisting of compounds of following Formulas 2, 3, and 4:

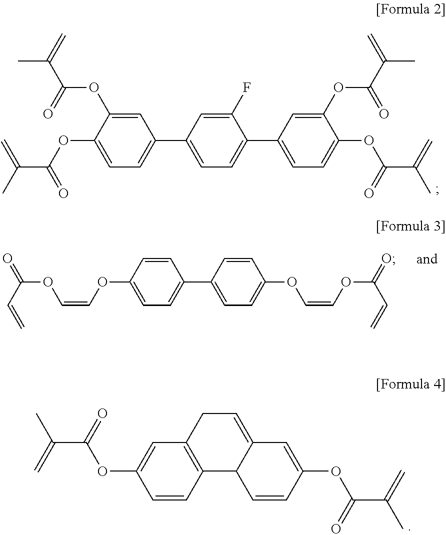

15. The method of claim 14, wherein the second reactive mesogen is selected from the group consisting of compounds of following Formulas 5, 6, 7, and 8:

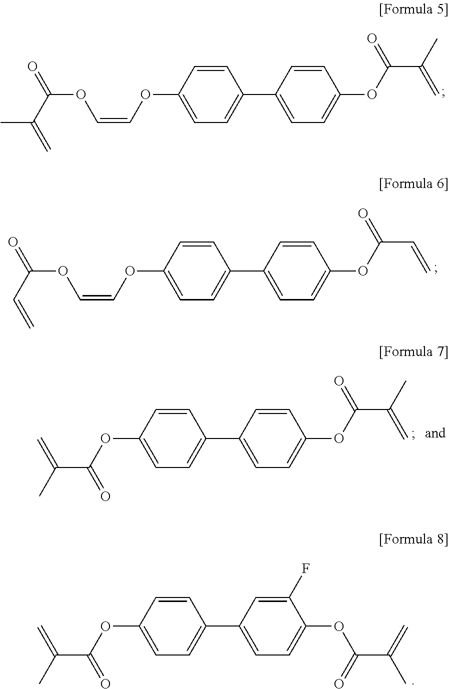

16. The method of claim 10, wherein the first light and the electric field are applied simultaneously.

17. The method of claim 10, further comprising forming a main alignment layer on at least one of the first substrate and the second substrate.

18. The method of claim 10, further comprising:
forming a pixel electrode on the first substrate; and
forming a common electrode on the second substrate,
wherein the pixel electrode and the common electrode are configured to form the electric field.

19. The method of claim 18, wherein the pixel electrode comprises a stem and branches extending from the stem.

20. The method of claim 19, wherein:
the first substrate comprises pixel regions having domains; and
the branches extend in different directions in each of the domains.
